(19) United States
(12) Patent Application Publication
(10) Pub. No.: US 2015/0348157 A1
(43) Pub. Date: Dec. 3, 2015

(54) DIGITAL TIMELINE LINKING MEDIA CONTENT

(71) Applicant: Edward O'Neil Garcia, Redwood City, CA (US)

(72) Inventor: Edward O'Neil Garcia, Redwood City, CA (US)

(21) Appl. No.: 14/320,330

(22) Filed: Jun. 30, 2014

Related U.S. Application Data
(60) Provisional application No. 62/007,362, filed on Jun. 3, 2014.

(51) Int. Cl. G06Q 30/06; G06F 17/30

(52) U.S. Cl. CPC G06Q 30/0625; G06Q 30/0643; G06F 17/30867

(57) ABSTRACT

Systems, computer-implemented methods, and computer-readable storage mediums for linking media content are disclosed. An online marketplace interface module provides content and receives, from a user device, a first message that includes target identification data identifying a target book character. A data access module accesses a database storing data structures. The respective data structures include character identification data, event data, and book identification data. The book identification data identifies content of the online marketplace related to the respective storyline events. A database management module provides timeline data for display on the user device. The timeline data, being based on the event data of a selected data structure, includes data for graphical indications of the one or more content indicated by the book identification data of the selected data structure.

### PRIORITY CLAIM UNDER 35 USC 119(e)

This application claims the benefit of priority of U.S. Provisional Patent Application Ser. No. 62/007,362, filed Jun. 3, 2014, which is incorporated herein by reference in its entirety.

### TECHNICAL FIELD

Example embodiments of the present application generally relate to online marketplaces and, more particularly, to a system and method for facilitating linking media content.

### BACKGROUND

Marketplaces can be online and/or real world (e.g., brick and mortar). Online marketplaces can include websites or mobile applications where users may buy or sell goods or services (referred to collectively as “items”) from a provider of the online marketplace or other users of the online marketplace. The goods or services (referred to collectively as “items”) are described in a published listing. Similar to online marketplaces, real-world online marketplaces may have websites that allows users to view inventory or interact with the real-world online marketplace. Increasingly, online market places are providing digital content, such as books, music, and movies. Consumers may view downloaded or streamed digital content on the home computers, laptops, and mobile devices.

### BRIEF DESCRIPTION OF THE DRAWINGS

In the drawings, which are not necessarily drawn to scale, like numerals may describe similar components in different views. Like numerals having different letter or numeric suffixes may represent different instances of similar components. The drawings illustrate generally, by way of example, but not by way of limitation, various embodiments discussed in the present document.

FIG. 1 is a network diagram depicting a client-server system, within which one example embodiment may be deployed.

FIG. 2 is a block diagram illustrating an example embodiment of a digital content system including multiple modules forming at least a portion of the client-server system of FIG. 1.

FIG. 3A is an interface diagram illustrating an example user interface, according to example embodiments.

FIG. 3B is an interface diagram illustrating an example user interface, according to an example embodiment.

FIG. 4 is a block diagram illustrating an example data structure including data fields for a character data structure, in accordance with an example embodiment.

FIG. 5 is a flowchart illustrating a method for providing a digital timeline, in accordance with an example embodiment.

FIG. 6 is an interaction diagram illustrating a method of providing a digital timeline, in accordance with an example embodiment.

FIG. 7 is a flowchart illustrating a method for selecting event data of a digital timeline, in accordance with an example embodiment.

FIG. 8 is a flowchart illustrating a method for filtering timeline data, in accordance with an example embodiment.

FIG. 9 is a flowchart illustrating another method for filtering timeline data, in accordance with an example embodiment.

FIG. 10 is a block diagram illustrating a mobile device, according to an example embodiment.

FIG. 11 is a block diagram of machine in the example form of a computer system within which instructions, for causing the machine to perform any one or more of the methodologies discussed herein, may be executed.

### DETAILED DESCRIPTION

Reference will now be made in detail to specific example embodiments for carrying out the inventive subject matter. Examples of these specific embodiments are illustrated in the accompanying drawings. It will be understood that they are not intended to limit the scope of the claims to the described embodiments. On the contrary, they are intended to cover alternatives, modifications, and equivalents as may be included within the spirit and scope of the disclosure as defined by the appended claims. In the following description, specific details are set forth in order to provide a thorough understanding of the subject matter. Embodiments may be practiced without some or all of these specific details. In addition, well known features may not have been described in detail to avoid unnecessarily obscuring the subject matter.

In accordance with the present disclosure, components, process steps, and/or data structures may be implemented using various types of operating systems, programming languages, computing platforms, computer programs, and/or general purpose machines. In addition, those of ordinary skill in the art will recognize that devices of a less general purpose or nature, such as hardwired devices, field programmable gate arrays (FPGAs), application specific integrated circuits (ASICs), or the like, may also be used without departing from the scope and spirit of the concepts disclosed herein. Embodiments may also be tangibly embodied as a set of computer instructions stored on a computer readable medium, such as a memory device.

Media content may involve complex, nonlinear, interweaving storylines. For example, storylines of some books involve multiple characters and/or may cover multiple editions, series, and volumes. In some cases, the storyline of one character may intersect with a storyline of another character. As such, part of a storyline of one character may be covered by a book that primarily focuses on another character. On example media content type that has complex storylines includes comic books. For example, a superhero (or villain) may be included in the comic book of another superhero. Accordingly, the superheroes' storylines intersect. Moreover, the storylines may be told in a nonlinear manner, such as non-chronologically and/or concurrently. A mini-series may focus on a backstory of a superhero, for instance, his childhood, while the regular series continues presenting the storyline of the adult superhero.

Rich, complex storylines can be incredibly entertaining and immersive. However, because the complexities, it may be difficult for readers to identify books that may interest them. For example, a reader may be unaware that a particular comic provides supplemental details of the death of the parents of his favorite superhero. Moreover, new readers may become discouraged from reading an established book series because of the learning curve involved. As a result, readers may miss opportunities to enjoy these rich storylines, and publishers miss sharing their media content.

Example methods and systems for linking media content (or simply “content”) of an online marketplace are described. In particular, a digital content system may provide a digital timeline of a character. The digital timeline may display chronologically storyline events associated with the character. Furthermore, for each storyline event, graphical indications of digital content associated with the storyline event may be displayed. The graphical indications may include linking data or code which may facilitate providing the user access to the corresponding digital content when the graphical indication is selected.

For example, a user may request digital timeline for superhero of a comic book. A digital content system may in response generate timeline data and provide the timeline data to the user device. The timeline data may include events described in multiple additions, volumes, or even another superheroes comic book. The timeline of events may be organized chronologically. When the user device renders the timeline, the user may scroll through the events associated with the superhero. For a particular storyline event, images associated with related books may be displayed near the particular storyline event. The related books include content that is related to the corresponding event. If the user selects or clicks on one of these images, the user device may render a webpage or software application for purchasing the comic book.

Examples of digital media content may include, but are not limited to, digital books (“eBooks”). Examples of types of digital books include novels, textbooks, comic books, cookbooks, and the like. Characters of media content may be fictional or non-fictional subjects. Moreover, characters of digital media may be human or non-human subjects. Although systems and methods for providing digital content will be described in the context of digital books, such as comic books, it will be appreciated that in alternative embodiments digital content may include images, video, audio, video games, or any suitable multimedia content being relatable to a timeline. In the following description, for purposes of explanation, numerous specific details are set forth in order to provide a thorough understanding of example embodiments. It will be evident, however, to one skilled in the art that the present invention may be practiced without these specific details.

Providing a digital timeline related to a selected character may improve the user experience in viewing digital content from an online marketplace. As described, the digital timeline effectively presents the storyline of a particular character, even where the storyline spans multiple volumes, additions, series, and/or the like of one or more types of media content. Moreover, the user may be able to discover digital content related to one or more storyline events of the character. The user may click on elements of the timeline to view additional information regarding the digital content and/or to purchase the digital content. Additionally or alternatively, for each storyline event, the digital timeline may provide information regarding different characters (“secondary characters”) who are involved with the storyline event. The user may click on a link associated with the secondary characters to bring up additional information and/or timelines related to the selected secondary character.

In an example embodiment, a digital content system may filter the data that is included in the digital timeline. For example, the amount of timeline data may be overwhelming if displayed in its entirety. As such, one or more storyline events, related digital content, and/or secondary character information may be selected to be included or to be omitted from the digital timeline provided to the user device. In an example embodiment, the digital content system may filter out storyline events that the user has not yet read.

In another example embodiment, “power rankings” may be determined. Power rankings may rank characters, storyline events related to a character or characters, or media content or merchandise related to one or more characters or storylines. A digital content system may determine the power rankings based on search term frequency; number of views; number of sales; in-marketplace ratings; in-book rankings; social network messages, shares, and recommendations (including “likes,” “tags,” “tweets,” and “retweets”); and the like user activities related to characters of digital content. Moreover, user interactions with the digital timelines may be tracked for generating character rankings. For example, the digital content system may track user activity for scoring characters. Accordingly, the digital content system may provide data to the user device for displaying the top ranked characters.

The digital content system may provide the data for any suitable graphical representation of the rankings, such as a bar graph. In operation, the user may select elements of the rankings to request marketplace resources (e.g., data or code related to a webpage or software application of the online marketplace) related to the selected character. Additionally or alternatively, the user may select elements of the rankings to request a digital timeline of the selected character.

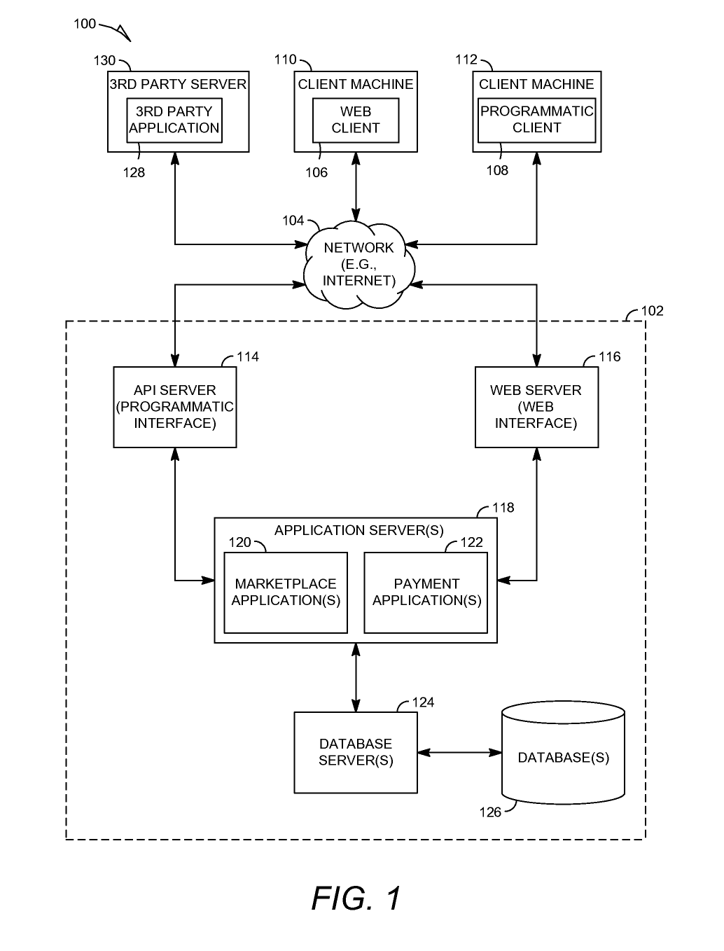

FIG. 1 is a network diagram depicting a client-server system 100, within which one example embodiment may be deployed. A networked system 102, in the example forms a network-based online marketplace or publication system, provides server-side functionality, via a network 104 (e.g., the Internet or Wide Area Network (WAN)) to one or more clients. FIG. 1 illustrates, for example, a web client 106 (e.g., a browser), and a programmatic client 108 executing on respective client machines/devices 110 and 112.

An Application Program Interface (API) server 114 and a web server 116 are coupled to, and provide programmatic and web interfaces respectively to, one or more application servers 118. The application servers 118 host one or more online marketplace applications 120, and payment applications 122. The application servers 118 are, in turn, shown to be coupled to one or more databases servers 124 that facilitate access to one or more databases 126.

The online marketplace applications 120 may provide a number of online marketplace functions and services to users that access the networked system 102. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for items that are made available via the online marketplace applications 120.

Further, while the system 100 shown in FIG. 1 employs a client-server architecture, the present invention is of course not limited to such an architecture, and could equally well find application in a distributed, or peer-to-peer, architecture system, for example. The various online marketplace and payment applications 120, 122 could also be implemented as standalone software programs, which do not necessarily have networking capabilities.

In addition, while the various online marketplace and payment applications 120, 122 have been described above as having separate functionalities, in alternative embodiments these functionalities may be performed by any one or more of the various online marketplace and payment applications 120, 122.

The web client 106 accesses the various online marketplace and payment applications 120 and 122 via the web interface supported by the web server 116. Similarly, the programmatic client 108 accesses the various services and functions provided by the online marketplace and payment applications 120 and 122 via the programmatic interface provided by the API server 114. The programmatic client 108 may, for example, be a seller application (e.g., the TURBOLISTER™ application developed by EBAY INC.™, of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, online marketplace, or payment functions that are supported by the relevant applications of the networked system 102.

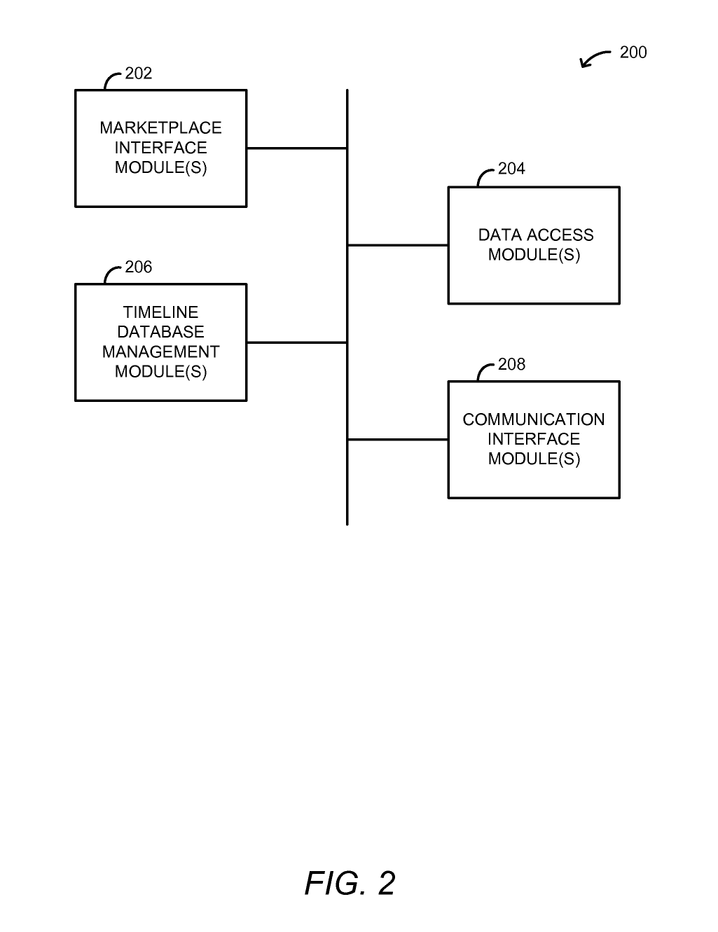

FIG. 2 is a block diagram illustrating an example embodiment of a digital content system 200 including multiple modules 202-208 forming at least a portion of the client-server system of FIG. 1. The modules 202-208 of the illustrated embodiment include an online marketplace interface module(s) 202, a data access module(s) 204, a timeline database management module(s) 206, and a communication interface modules(s) 208. In some embodiments, the components of the digital content system 200 can be included by the online marketplace application 120 of FIG. 1. However, it will be appreciated that in alternative embodiments, one or more components of the digital content system 200 described below can be included, additionally or alternatively, by other devices, such as one or more of the servers 114, 116, 118, 130, the network 104, and/or the client machines 110, 112 of FIG. 1.

Accordingly, the modules 202-208 of the digital content system 200 may be hosted on dedicated or shared server machines that are communicatively coupled to enable communications between server machines. Each of the modules 202-208 is communicatively coupled (e.g., via appropriate interfaces) to each other and to various data sources, so as to allow information to be passed between the modules 202-208 or so as to allow the modules 202-208 to share and access common data. The various modules 202-208 may furthermore access one or more databases servers 124 that facilitate access to one or more databases 126.

The digital content system 200 may facilitate providing a digital timeline of events spanning over a plurality of digital content. In one aspect, users may provide input that causes the user device 110 to request the digital timeline. The input may correspond to clicking on the hyperlink displaying the selected character's name. The hyperlink may be displayed as part of a digital book or digital content, or as part of a marketplace resource. The marketplace resource may include data corresponding to a webpage or software application of the online marketplace. In response, the digital content system 200 may generate and provide timeline data for the user device 110. Additionally or alternatively, the digital content system 200 may filter data to be included in the timeline data, as will be described in greater detail below.

The online marketplace interface module 202 may be a hardware-implemented module which may provide data to facilitate one or more online marketplaces. For example, the online marketplace interface module 202 may provide access to items of the online marketplaces for display on user devices. The items may include one or more media content items (e.g., music, videos, books, etc.). A user may access an item by downloading and/or streaming digital content. Access to the digital content may be provided in accordance with a purchase transactional model and/or an advertisement-based transaction model.

In operation, the online marketplace interface module 202 may provide access to books for purchase. Moreover, the online marketplace interface module 202 may receive, from a user device, a message including target identification data identifying a target character who is the subject of one or more types of digital content. In response to the message, the online marketplace interface module 202 may pass the target identification data and/or the user identification to one or more modules of the data content system 200 for generating timeline data associated with the target character.

An example embodiment, online marketplace interface module 202 may facilitate users selecting digital character cards of comic book characters. For example, in response to receiving an indication of a character selection, the user interface displayed on the user device may provide information related to the corresponding character. In particular, the user interface may have the look of a collectible character card, displaying images, facts, and/or attributes related to the selected character. The user may click on the character card, and the character card may flip over to display the digital timeline.

The data storage interface module 204 may be a hardware-implemented module which may store data and provide access to the stored data. For example, the data storage interface module 204 may access a data storage device for storing character data structures and or filtering data. In operation, the data access module 204 may access a database storing one or more character data structures. For example, a character data structure may include character identification data, event data, and content identification data, among other data. The character identification data may be used to match the target identification data to a matching character data structure. The event data may be indicative of storyline events of digital content related to the character. Content identification data may be associated with each event of the event data. In particular, the content identification data may identify one or more media content of the online marketplace that include the corresponding storyline event. The content identification data may include a computer readable address for locating the corresponding book in the online marketplace database.

The timeline database management module 206 may be a hardware-implemented module which may facilitate accessing and selecting data from a database for providing timeline data to a user device. For example, the timeline database management module 206 may generate the timeline data based on event data of a selected character data structure. As stated, the timeline rendered on the user device may link to one or more digital content of the online marketplace. Accordingly, the timeline data may include data for graphical indications of the one or more media content indicated by the content identification data of the selected character data structure. The graphical indications may correspond to a selectable image such as a cover page of a corresponding book. The graphical indications may, alternatively or additionally, include a hyperlink for accessing a webpage or to invoke a software application providing access to the corresponding media content.

The database management module 206 may determine whether the target identification data matches respective character identification data of the character data structures accessed by the data access module 204. Furthermore, the database management module 206 may select one of the character data structures in accordance with the target identification data matching the character identification data of the corresponding data structure. The database management module 206 may provide, for display on the user device, timeline data based on the event data of the selected character data structure.

### Example User Interface

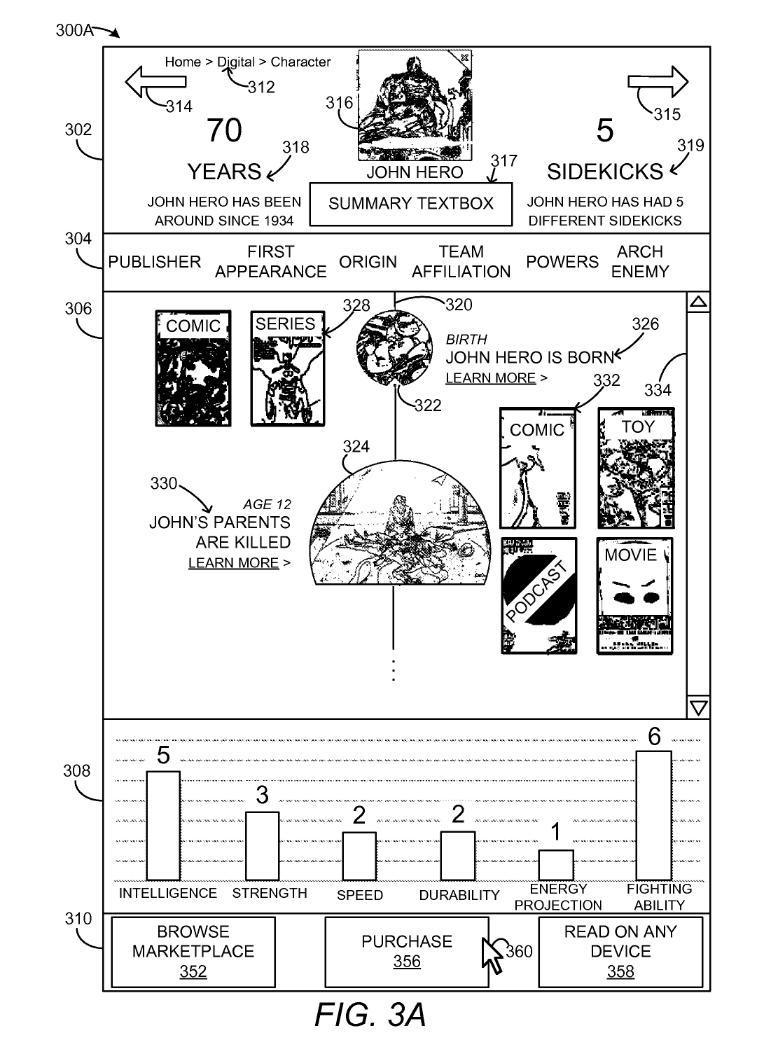

FIG. 3A is an interface diagram illustrating an example user interface 300A, according to example embodiments. In particular, the illustrated user interface 300A of FIG. 3A may be rendered in accordance with data provided by one or more of the modules 202-208 of FIG. 2 to a user device, such as the user device 110 of FIG. 1. The user device may render the user interface 300A on at least a portion of a display of the user device. For example, the user interface 300A may provide graphical indications of the plurality of events related to the selected character. For each of the displayed events, user interface 300A may provide elements corresponding to respective one or more related media content, such as a digital book. These elements may be selected by the user for accessing the selected media content. In this way, the user interface 300A provides an organized way to display media content related to selected characters. Accordingly, the user interface 300A may facilitate discovery of media content that may be of interest to the user and may encourage sales of the digital content.

The user interface 300A includes frames 302, 304, 306, 308, 310. The frame 302 includes control elements 312, 314, 315 and display elements 316, 317, 318, 319. The frame 306 includes the digital timeline 320 comprising one or more storyline events 322, 324. Associated with respective events 322, 324, the frame 306 includes text 326 and images 328 for the storyline event 322 and text 330 and images 332 for the storyline event 324. It will be appreciated that more or less storyline events may be displayed with their associated text and images. The frame 306 may include a control element 334 to scroll the display of the contents of frame 306 in one or more directions. Frame 310 may include control elements 352, 356, 358. The user interface 300A may also include display element 360 for graphically indicating a location of a user input, for example the current position of the mouse input device. More or less frames or elements of the user interface 300A may be included in alternative embodiments. Although user interface 300A will be described in the context of a character of a comic book, it will be appreciated that the character need not be a character of a comic book, but may be a character of any type of media content.

The frame 302 of the user interface 300A may provide control elements that may facilitate navigation between one or more other instances of user interfaces for digital timelines for different characters. For example, the frame 302 includes the control element 312 for navigating directories or folder hierarchies. In the illustrated example embodiment, the control element 312 shows that the user interface 300A is associated with a character within the home/digital/character directory. The elements “home,” “digital,” “character” may correspond separate hyperlinks such that selecting one of the elements will invoke a user interface display associated with the selected element. Furthermore, the user interface 300A includes the control elements 314, 315 for sequentially navigating timelines of different characters. For example, the control elements 314, 315 may correspond to buttons that, when selected, switch the user interface 300A to display the next character in sequence. For example, selecting control element 314 may switch the display to a user interface associated with a previous character and selecting the control element 315 may switch the display to a user interface associated with a subsequent character.

The frame 302 of the user interface 300A may further provide display elements that may graphically provide information related to the selected character. In the illustrated example embodiment, the display element 316 provides an image of the selected character. The display element 317 may provide text describing the selected character. The text of the display element 317 may summarize biographical information related to the selected character. Furthermore, the display elements 318, 319 may provide trivia or interesting facts related to the selected character. As shown, the user interface 300A provides two facts, one displayed to the left of the display element 316 and one to the right of the display element 316. In an example embodiment, the facts displayed are selected from a plurality of facts. As such, when the user interface 300A is displayed, two facts are selected for display. In this way, the user interface 300A may vary the set of facts displayed and thereby making the user interface 300A more interesting on repeated visits.

The frame 304 of the user interface 300A may provide display elements that may graphically provide publication information related to the selected character. In the illustrated example embodiment, the user interface 300A displays the publisher, first appearance (e.g., comic book), the origin of the character (city, country, planet, universe, etc.), the team affiliation, powers, and the archenemy associated with the selected character.

The frame 306 of the user interface 300A may provide display and control elements for graphically displaying the digital timeline 320 association with the selected character. The digital timeline 320 may display the storyline events 322, 324 sequential order. The storyline event 322 is displayed along with text 326 for displaying summary information regarding the storyline event 322. The text may include, for example, an age of the selected character, a title, and/or a hyperlink. In the illustrated example embodiment, the user interface 300A shows that the event 322 corresponds to the selected character being born, as indicated by the age being “Birth” and the title being “John Hero is born.” In operation, if the user selects the hyperlink “learn more,” and the user interface 300A may navigate to a user interface display that provides further details regarding the related storyline event.

Furthermore, the frame 306 of the user interface 300A may provide display elements for graphically displaying one or more items that are related to the storyline events 322, 324. The items may correspond to media content, merchandise, and the like items. Examples of media content include books, video (television shows, movies, animations, etc.), images (artwork, photography, drawings, posters, etc.), audio (music, audio shows, podcasts, etc.), and multimedia (including video games). Media content may be embodied in physical or digital formats. Examples of merchandise may include toys (e.g., figurines), model objects, lunch boxes, clothing, board games, and the like.

For example, in the illustrated example embodiment, the two images 328 are shown along with the storyline event 322. The two images 328 may be related to a book and a mini-series of books that include the birth of John Hero as part of the storyline of the respective media content of the images 328. In connection with the event 324, the four images 332 may be related to a book, a collectable toy, a podcast, and a movie that are related to the death of John Hero's parents. In operation, if the user selects one of the images 328, 332, the user interface 300A may navigate to a user interface display (for example, of an application or a webpage) that provides further access to the digital content or merchandise of the selected image 328, 332. For example, the digital content system 200 may provide marketplace resources for accessing, displaying, or purchasing the media content or merchandise.

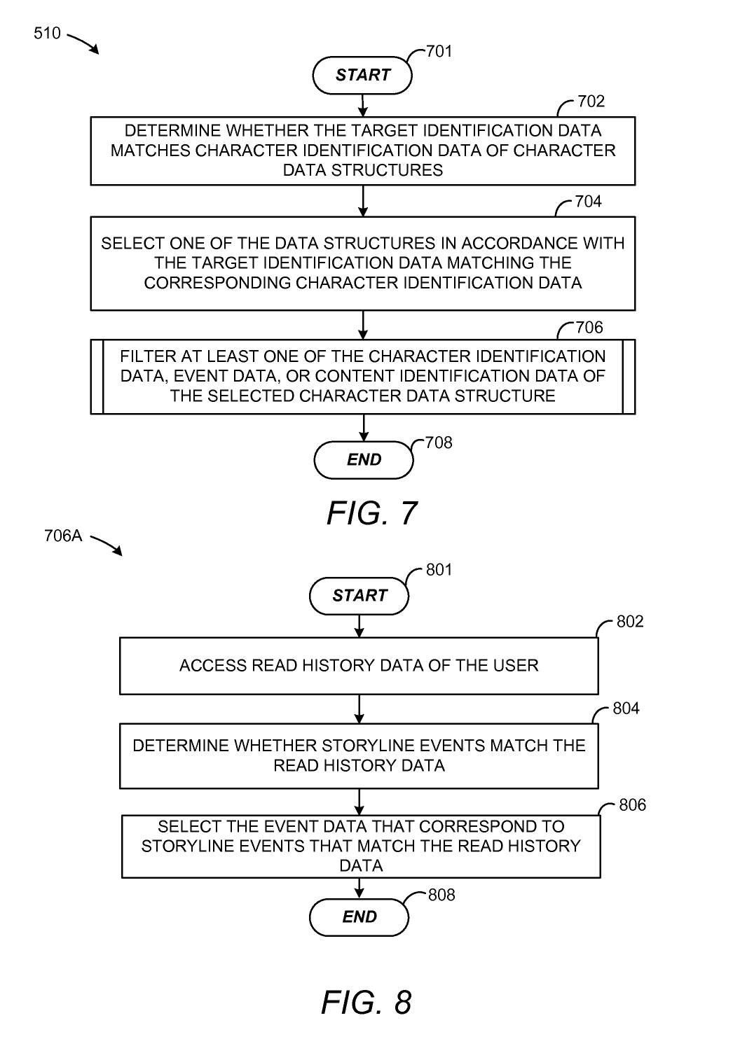

In an example embodiment, the events that are displayed by the user interface 300A may be filtered. For example, the storyline events 322, 324 may have been selected from a plurality of candidate storyline events, wherein one or more of the plurality of candidate storyline events may not have been selected for display. For example, the online marketplace interface module 202 may select event data for the timeline data based on use or read history data of the user. The read history may include data indicative of the reading progress of the user for each of one or more books. If an event corresponds to a portion of a book that the user has read, then the event may be selected for display. In this way, the digital timeline may avoid revealing “spoilers.” Filtering may also be based on data indicative of one or more events given priority. Priority events may include events that should always be displayed due to their importance, such as the birth, first appearance, and the like. Priority events may also include events that the online marketplace, retailer, and/or publisher may be promoting. Filtering event data will be described in greater detail later in connection with FIG. 8.

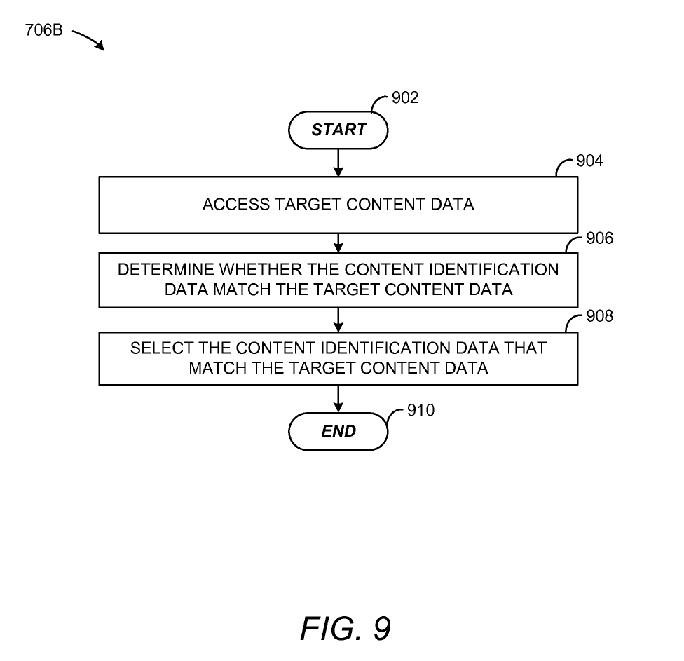

In an example embodiment, the related items presented (e.g., via the images 328, 332) with each of the storyline events 322, 324 may be filtered. For example, the items corresponding to the images 328, 332 may be selected from a plurality of candidate items, wherein one or more of the items may have not been selected for display. For example, the online marketplace interface module 202 may select content identification data for the timeline data based on data indicative of priority to one or more media content. Media content with priority may include media content that are displayed based on their importance, such as books that described the selected event for the first time. Media content with priority may also include media content that are promoted by the online marketplace, retailer, and/or publisher. Filtering book data will be described in greater detail later in connection with FIG. 9.

As shown in the illustrated example embodiment, the storyline events 322, 324 are displayed with images. These images may be displayed with varying sizes. In one example, the sizes may be determined based on data indicative of the importance of the event. Additionally or alternatively, the sizes may be determined based on the number of media content and merchandise associated with the storyline event. For example, the event 324 is displayed larger than the event 322, where event 324 has more items (e.g., images 332) than event 322 does. Additionally or alternatively, the sizes of the events 322, 324 may be determined based on sales of media content and merchandise related to the respective events.

The frame 308 of the user interface 300A may provide display elements that may graphically provide publication information related to the selected character. For example, the frame 308 may display numerical values associated with respective attributes, such as, but are not limited to, intelligence, strength, speed, durability, energy projection, and/or fighting ability. In this way, the user interface 300A may serve as a “character card” of the selected.

The frame 310 of the user interface 300A may provide control elements that may facilitate receiving user input. For example, the control element 352 may correspond to a selectable button to browse the online marketplace. The control element 356 may correspond to a selectable button to purchase a selected digital content displayed by the user interface 300A. The control element 358 may correspond to a selectable button to read a selected digital content on a device associated with the user.

FIG. 3B is an interface diagram illustrating an example user interface 300B, according to an example embodiment. The user interface 300B may provide graphical indications of rankings and digital timelines. In the illustrated example embodiment, the user interface 300B includes a window 362 having first and second frames 364, 366. The frame 364 includes rankings (e.g., “power rankings”) of characters. The frame 366 includes a digital timeline 320 comprising one or more storyline events 322, 324, 325, 327, 329. The frame 366 may also include representations of digital content 328 and control elements 352, 356, 258, 370, 372. Elements common to FIGS. 3A and 3B share common reference indicia, and only differences between the Figures are described herein for the sake of brevity. Furthermore, it will be appreciated that more or less elements of the user interface 300B may be included in alternative embodiments.

The illustrated user interface 300B of FIG. 3B may be rendered by the user device 110 of FIG. 1 in accordance with data provided by one or more of the modules 202-208 of FIG. 2. As will be described below, the user interface 300B may facilitate organizing and accessing media content by providing rankings and/or scores. As a result, the user interface 300B may provide a way for users to discover media content and may encourage sales of digital content.

As stated, the frame 364 of the window 362 may display rankings of characters. However, it will be appreciated that the frame 364 may display rankings of other items, such as media content series, storyline events, and the like. The items may be ranked based on user inputs related to interactions with digital content, online marketplaces, or digital timelines. For example, the digital content system 200 (such as the marketplace interface module 206) may access a database storing records of one or more user inputs related to each character. Each type of user input may be assigned a value, and a score of a character may be determined by combining or summing the values of the user inputs associated to the character. Accordingly, characters may be ordered based on their scores to determine the rankings.

The user interface 300B may provide rankings that have selectable items. For example, the user device 110 may receive user input indicative of a selection of an item of the rankings as an input and may provide the digital content system 200 an indication of the selection as an output. For example, the rankings of the frame 364 show that the character “John Hero” as having been selected. In response to the selection, the digital content system 200 may provide to the user device 110 data related to the selected item. In one example embodiment, as will be described below in greater detail, the data provided by the digital content system 200 may correspond to the digital timeline 320 of a selected character of the ranking. In another example embodiment, the data may correspond to a marketplace resource for accessing the selected item of media content.

The frame 366 may display information related to a selected item of the ranking displayed in the frame 364. In the illustrated embodiment, the frame 366 may display the timeline 320 of the selected character “John Hero.” The timeline 320 may be represented as a bar graph for providing a graphical indication of scores for the respective storyline events 322, 324, 325, 327, 329. However, the timeline 320 may be represented by any suitable graphical representation for organizing storyline events, with or without graphical indications of scores. For example, the scores may be presented numerically as text displayed near the associated storyline event. When scores are used, the scores for the storyline events may be determined in a manner similar to the way that scores were described above in connection with the rankings of frame 364.

The storyline events 322, 324, 325, 327, 329 of the timeline 320 may be selectable. In operation, the user may use the pointer 360 to select a storyline event of the timeline 320 to request marketplace resources related to the selected event. For example, in the illustrated embodiment of FIG. 3B, the event 322 (“Birth”) is shown as having been selected. Accordingly, the digital content 328 associated with the event 322 are shown. It will be appreciated that other types of items may be displayed, such as merchandise. The user may then select one of the items of the event 322 to access the selected item or to purchase the selected digital content. Furthermore, the user may select another event, such as event 324, to display the digital content associated with the new event. Additionally, the frame 366 may remove the digital content 328 in response to the user selecting another event. In an alternative embodiment, digital content for more than one event may be displayed simultaneously, for example, on displays having sufficient display area.

The control element 370 may facilitate controlling the number of events displayed on the timeline 320. For example, as the user moves the slider in one direction (e.g., right), the number of events to be display may increase; and as the user moves the slider in another direction (e.g., left), the number of events to be displayed may decrease. The control element 370 may directly control the number of events to be displayed. Additionally or alternately, the control element 370 may indirectly control the number of events to be displayed. For example, the control element 370 may adjust the minimum time between events and/or adjust a threshold score for displaying an event. For example, the digital content system 200 or the mobile device 110 may determine whether an event has a score greater than a threshold, in accordance with the control element 370. The event may be displayed (or may be provided to the user device 110 by the digital content system 200) in response to a determination that the event has a score greater than the threshold. Otherwise, the even may not be displayed (or may not be provided to the user device 110 by the digital content system 200). The scroll bar 372 may be used to scroll the timeline 320 when the events to be displayed do not fit within the display area.

The rankings displayed in frame 364 and the scores of the events of frame 366 may be determined based on user selections, search term frequencies, number of views, number of sales, in-marketplace ratings, in-book rankings, in-book highlights and annotations, social network shares and recommendations (including “likes”), and such user activities related to digital content or the characters and events of digital content.

Moreover, user interactions with digital timelines (e.g., the digital timeline 320 of FIGS. 3A and 3B) may be tracked for generating rankings digital content, events, or characters. For example, the digital content system 200 may track and record user interactions with the digital timelines of user interfaces 300A, 300B. For example, user clicks of events, characters, and digital content may be recorded. Furthermore, user interactions with the user interfaces 300A, 300B that result in accessing or purchasing digital content may be recorded. Data of user interactions may be included in one or more records for digital content, characters, or events.

User interface 300B may be provided by the digital content system 200 in response to the digital content system 200 receiving a message form the user device 110. For example, the marketplace interface module 206 may receive, from the user device 110, an indication that the user has requested data for rankings. The request may correspond to a user interaction with an online marketplace webpage or application or with digital content (e.g., by selecting text or an image corresponding to a character). The request may be transmitted from the user device to the digital content system 200.

### Example Data Structure

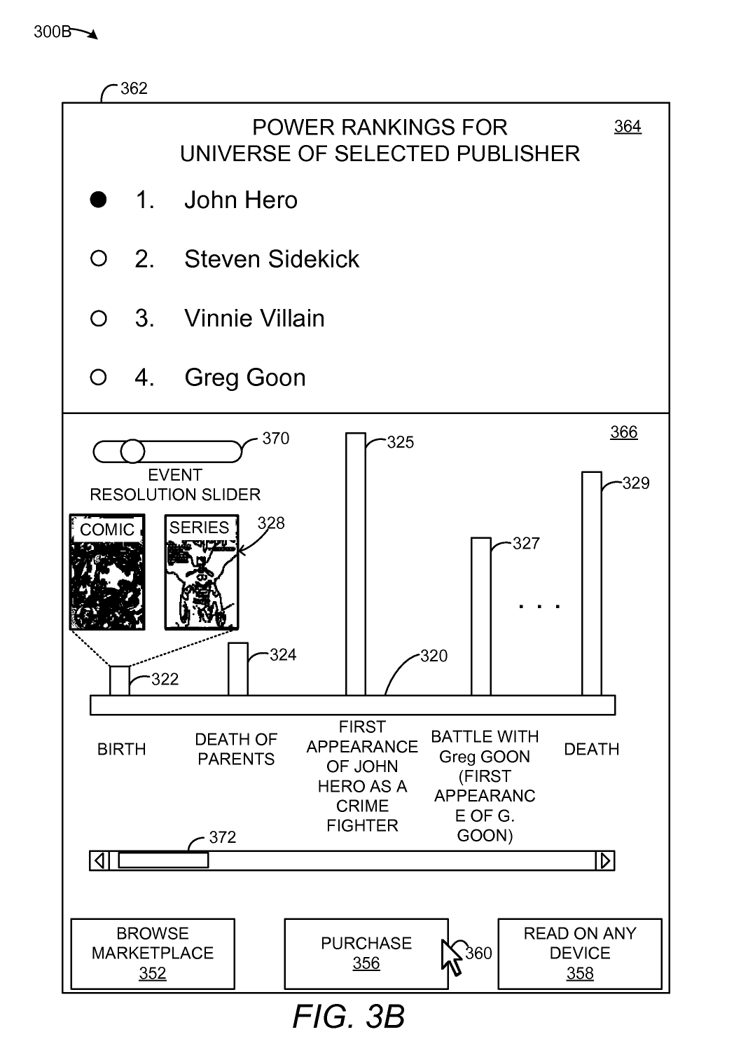

FIG. 4 is a block diagram illustrating an example data structure 400 including data fields 406-430 for a character data structure, in accordance with an example embodiment. The data structure 400 may correspond to character-event data stored in a database 126 communicatively coupled to the network-based online marketplace 102. Alternatively, one or more of the elements of the data structure 400 may be stored by any of the servers or client devices of FIG. 1.

The illustrated data structure 400 of FIG. 4 may serve as a data structure for storing, organizing, and generating timeline data. The data structure 400 includes a character ID data field 406, a profile image data field 408, a facts data field 410, and an event data array 412. The event data array 412 may include one or more event data structures, such as data structure 414. The event data structure 414 includes an event ID data field 420, a date data field 422, a link data field 424, a related characters data field 426, a related products data field 428, and a visibility data field 430. In alternative embodiments, the character data structure 400 and/or the event data structure 414 may include more or less data fields.

The character ID data field 406 may correspond to data indicative of a corresponding character. For example, the content ID data field 504 may correspond to any value, such as a binary or alpha-numerical identification code, suitable for associating the character data structure 402 with a particular character. In data storage, one or more instances of the data structure 400 may be organized by character ID data field 406.

The profile image data field 408 may correspond to image data representing the character associated with the character ID data field 406. The image may be displayed as part of the user interface 300A, such as the display element 316. The facts data field 410 may correspond to data describing one or more facts or trivia of the character associated with the character ID data field 406. For example, the data may correspond to text data displayed by the display elements 318, 319 of the user interface 300A. The event data array 412 may correspond to data describing one or more storyline events associated with the character of the character ID data field 406. The data array 412 may be used to generate the digital timeline 320 of FIG. 3A.

The event ID data field 420 of the event data structure 414 may correspond to data indicative of a corresponding storyline event. For example, the event ID data field 420 may correspond to any value, such as a binary or alpha-numerical identification code, suitable for associating the event data structure 414 with a particular event. The event ID data field 420 may also include data for generating title of the text 326, 330 of the user interface 300A. The date data field 422 of the event data structure 414 may include data indicative of a date of the event or the age of the character when the event occurred. The date data field 422 may be used to generate the text elements 326, 330 of the user interface 300A. The link data field 424 of the event data structure 414 may correspond to data for linking the user interface 300A to another user interface display (e.g., of an application or a webpage) providing additional information regarding the event. The link data field 424 may be used to generate “learn more” hyperlinks for text elements 326, 330 of the user interface 300A.

The related characters data field 426 of the event data structure 414 may correspond to data indicative of characters associated with the event of the event data structure 414. User interface elements may be provided to link the user to online marketplace resources for accessing digital content and/or visual timelines related to the related characters the event. The related products data field 428 of the event data structure 414 may correspond to data indicative of media content or merchandise (identification data corresponding to the items shown in the images 328, 332) associated with the event and or character. User interface elements may be provided to link the user to online marketplace resources for purchasing the merchandise. The visibility data field 430 of the event data structure 414 may correspond to data indicative of the visibility level of the event. For example, the visibility data field 430 may indicate that the effect should always be shown. In another example, the visibility data field 430 may indicate that the event should only be shown the user has read digital content that includes the present event.

### Example Process for Providing Digital Timelines

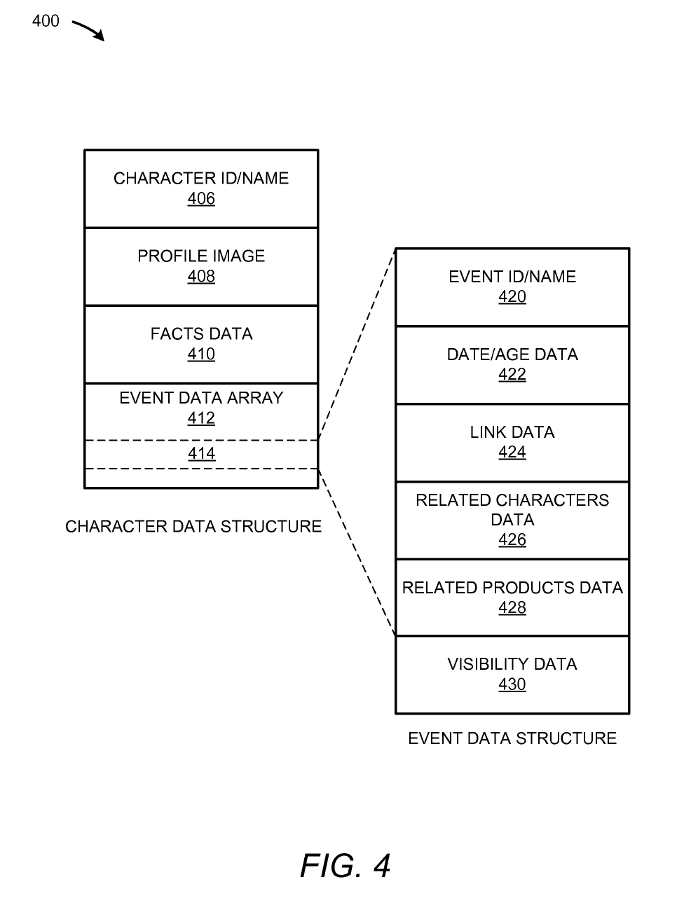

FIG. 5 is a flowchart illustrating a method 500 for providing a digital timeline, in accordance with an example embodiment. In this example, the method 500 may include operations such as providing media content for online purchase 504, receiving a first message 506, accessing a database 508, and providing timeline data 510. The example method 500 will be described, by way of explanation, below as being performed by certain modules. It will be appreciated, however, that the operations of the example method 500 can be performed in any suitable order by any number of the modules shown in FIG. 2.

The method 500 may start at block 502 and proceed to block 504 for providing data of an online marketplace for facilitating purchasing digital content. In one embodiment, the online marketplace interface 202 may provide data to the user device for displaying a user interface 300A of the online marketplace.

At block 506, the method 500 may include receiving a message that includes target identification data of a target book character. For example, the marketplace interface module 202 may receive the first message from the user device. The first message may be a request for timeline data associated with a target character. The first message may be transmitted by the user device 110 over the network 104 to the application server 118. The user device 110 may provide the message in response to the user selecting the character within the digital content. For example, a character may be selected by text or an image that includes a hyperlink. The hyperlink may be part of a digital media content, an software application, or a website, such as the online marketplace. Moreover, the hyperlink may cause the user device 110 to generate the message, responsive to selection of the hyperlink, such that the message includes the target identification data of the target character.

At block 508, the method 500 may include accessing a database storing character data structures. Each of the character data structures may correspond to the data structure 400 of FIG. 4. In particular, the character data structure may include character identification data, event identification data, and content identification data. In an example embodiment, the marketplace interface module 202 may generate a request to the timeline database management module 206 based on the received message a block 506. The request may include the target character identification data so that the timeline database management module 206 may select the appropriate character data structure. In turn, the timeline database management module 206 may access, via the data access module 204, a data storage device storing the character data structures.

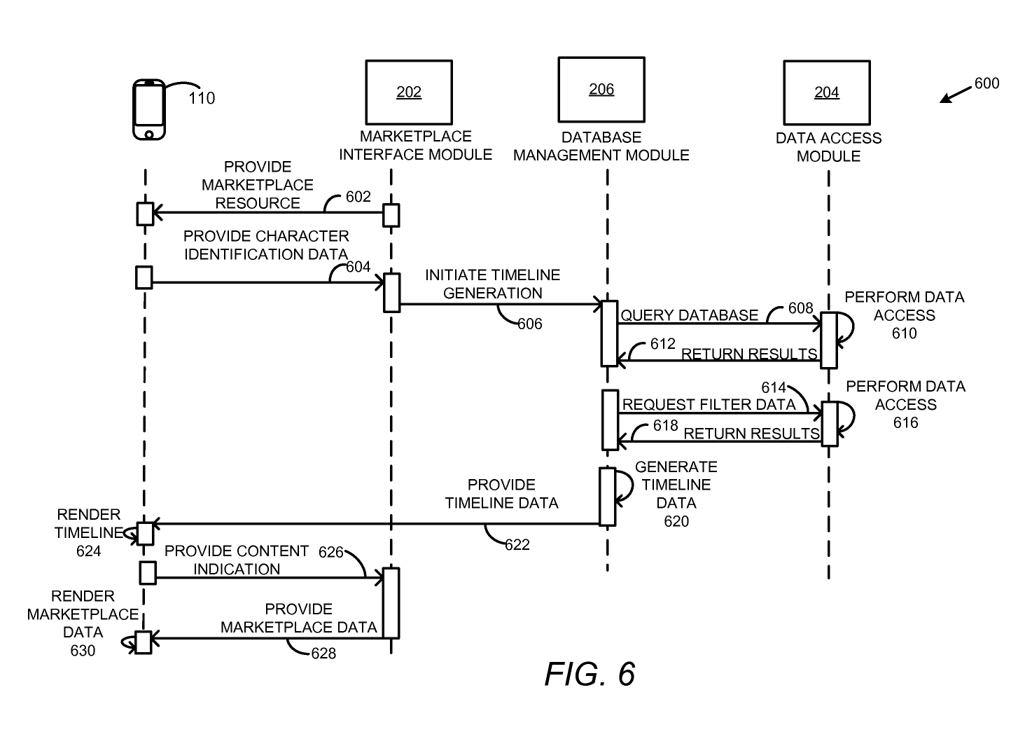

At block 510, the method 500 may include providing timeline data based on the event data and the content identification data of a selected character data structure. The timeline data may correspond to one or more of the data fields 406-430 of FIG. 4. Methods of providing timeline data will be described in greater detail later in connection with FIGS. 7, 8, and 9. After providing timeline data, the method 500 may end at block 512.

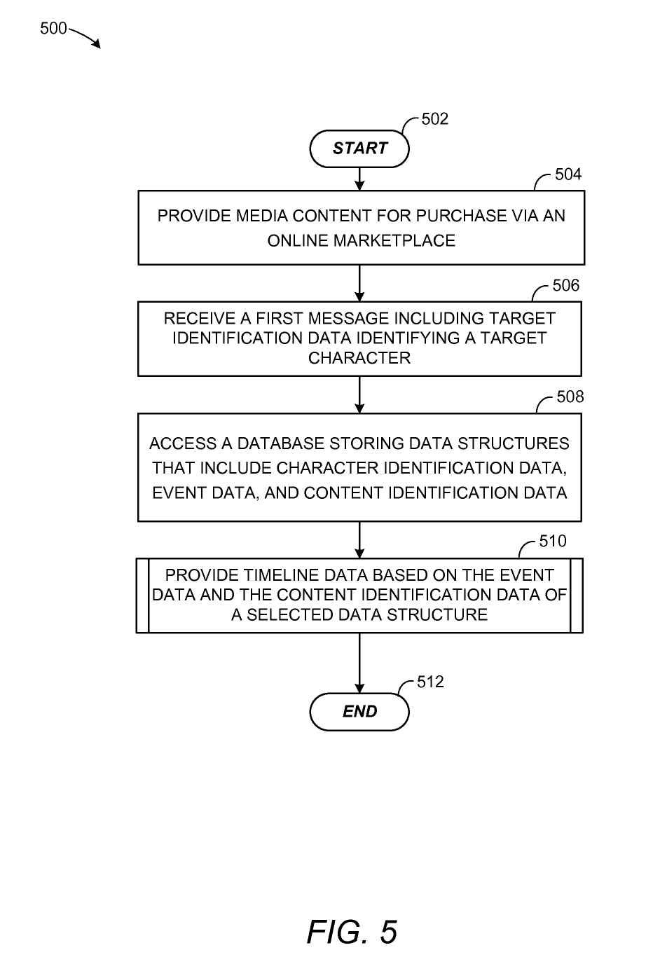

FIG. 6 is an interaction diagram illustrating a method 600 of providing a digital timeline, in accordance with an example embodiment. In particular, FIG. 6 illustrates interactions between a user device 110 and modules 202, 204, 206 of FIG. 2.

The digital content marketplace network 200 may provide access to media content for purchase. For example, at operation 602, the marketplace interface module 202 provides a marketplace resource to the user device 110. The marketplace resource may include data corresponding to a software application executed by the user device 110 or a webpage rendered on the user device 110. At operation 604, the user device 110 may provide target identification data to the market interface module 202. For example, the user device 110 may provide the target identification data of a character in response to the user selecting a hyperlink of text displaying the name of the corresponding character. The hyperlink may be included as part of a digital media content or as part of an online marketplace interface.

In response to receiving the target identification data at operation 604, the marketplace interface module 202 may, at operation 606, initiate timeline data generation. For example, in the illustrated example embodiment, the marketplace interface module 202 may call the database management module 206 in order to generate timeline data to provide to the user device 110. In response, the database management module 206 may query the database by using the database access module 204. For example, the database management module 206 may match the target identification data to a character data structure of the database. At operation 610, the data access module 204 performs the data access and, at operation 612, returns the results to the database management module 206.

An example embodiment, the database management module 206 may perform further filtering of the data of the character data structure. Filtering may be based on data stored in a data storage device. Filtering data, for example, may correspond to a user purchase history, read history, marketing data, and the like. As stated, purchase history and/or read history may be used for filtering out one or more events as a way to avoid “spoiling” storylines for the user. Furthermore, marketing data may be used in order to promote selected media content.

Accordingly, the database management module 206 may request filter data from the data access module 204. In turn, the data access module 204 performs the data access at operation 616 and then, at operation 618, returns the results the database management module 206.

At operation 620, the database management module 206 may generate the timeline data for generating a timeline of storyline events related to the target character identified by the character identification data of operation 604. For example, timeline data may be generated based on the character data structure accessed at operation 610 and filtered based on the filter data returned at operation 618. At operation 622, the database management module 206 provides the timeline data to the user device 110.

At operation 624, the user device renders the digital timeline based on the timeline data provided at operation 622. For example, the rendered timeline may correspond to the user interface 300A described in connection with FIG. 3A. As stated, each of the storyline events may be displayed along with one or more elements corresponding to media content related to the storyline event. In an example embodiment, the user device may receive user input corresponding to a selection of one of the elements corresponding to the media content. Accordingly, at operation 626, the user device 110 may provide book identification data to the marketplace interface module 202. At operation 628 the marketplace interface module 202 may provide the marketplace data to the user device 110. At operation 630, the user device 110 may render the marketplace data 630. For example, the user device 110 may display a user interface of a web page for a software application that may be used to purchase media content matching the book identification of operation 626.

FIG. 7 is a flowchart illustrating a method 510 for selecting event data of a digital timeline, in accordance with an example embodiment. In this example, the method 510 may include operations such as determining whether target identification data matches character identification data of data structures 702, selecting one of the character data structures 704, and filtering at least at least a portion of the selected character data structure 706. The example method 510 will be described, by way of explanation, below as being performed by certain modules. It will be appreciated, however, that the operations of the example method 510 can be performed in any suitable order by any number of the modules shown in FIG. 2. Moreover, more or less operations may be included by the example method 510.

The method 510 starts at block 701 and proceeds to block 702 for determining whether target identification data matches character identification data of character data structures. The target identification data may have been included in a message received from the user device. The message may correspond to a request for timeline data. The character identification data may be included in character data structures that correspond to the character data structure 400 of FIG. 4. In an example embodiment, the online marketplace interface module 202 determines the target identification data in response to receiving the message from the user device. In turn, the marketplace interface module 202 passes the target identification data to the database management module 206 for querying a database stored on a data storage device by using the data access module 204. The database may be queried by accessing one or more character data structures 400 and determining whether the accessed character data structures have a character identification data field 406 that matches the target identification data.

At block 704, the method 510 may include selecting one of the character data structures in accordance with the target identification data matching the character identification data of the corresponding character data structure. For example, the database management module 206 may select the character data structure in response to a determination that the character data structure has a character identification data field 406 that matches the target identification data. The data access module 204 may return the matching character data structure to the database management module 206.

At block 704, the method 510 may include filtering at least one of the event data or book identification data of the selected data structure. An example embodiment, the database management module 206 accesses filtering data that is stored in a data storage device. The filtering data may correspond to data that can be used to determine which data of the character data structure can be used in generating the timeline data for the client device. Example embodiments of filtering will be described below in greater detail in connection of FIGS. 8 and 9. In some embodiments, block 706 may be omitted. At block 708, the method 510 may end.

FIG. 8 is a flowchart illustrating a method 706A for filtering timeline data, in accordance with an example embodiment. The method 706A may be used to filter out event data from the timeline data. In this example, the method 706A may include operations such as accessing read history of the user 802, determining whether storyline events match the read history data 804, and selecting the event data based on the determining 806. The example method 706A will be described, by way of explanation, below as being performed by certain modules. It will be appreciated, however, that the operations of the example method 706A can be performed in any suitable order by any number of the modules shown in FIG. 2.

The method 706A, starting at block 801 and proceeding to block 802, includes accessing read history of the user requesting timeline data. For example, the database management module 206 may access the read history data of the user by accessing a database 126 using the data access module 204. The read history may include data indicating the books that the user has read, the pages of the books that the user has accessed, the progress of the books that the user has accessed, or any suitable data for determining whether the user has accessed a portion of digital content related to a storyline event. The read history data of the users of the digital content system 200 may be maintained by the marketplace interface module 202.

After accessing the read history data of the user, the method 706A may proceed to block 804 for determining whether storyline events of the selected character data structure match the read history data. As stated, the selection of the character data structure may have been performed as described in connection with block 704 of method 510 of FIG. 7. In an example embodiment, the database management module 206 may determine whether the portions of the digital content accessed by the user correspond to the respective storyline events indicated by the event data array 412 of the character data structure 400. For example, the database management module 206 may access a data table that maps locations of digital content to storyline events. According, the database management module 206 may utilize the database table by determining whether the events indicated by the event data array 412 match the results of the data table indexed by the read history data of the user.

After determining whether storyline events of the selected character data structure match the read history data, the method 706A may proceed to block 806 for selecting the event data that correspond to storyline events that match the read history data. For example, the database management module 206 may include the selected storyline events in the timeline data that is to be provided to the user device. In this way, storyline events that the user may not have previously known about will not be provided to the user. As result, the filtering of the event data may facilitate avoiding spoiling storyline events for the user. At block 808, the method 706A may end.

In an example embodiment, logic for spoiler alerts may be provided. For example, the user may provide user input corresponding to a spoiler sensitivity level for displaying storyline events. The spoiler sensitivity level may indicate to show all spoilers, to show only spoilers from certain media content, and/or to show only spoilers having a certain value, such as high, medium, and/or low spoiler sensitivity.

FIG. 9 is a flowchart illustrating another method 706B for filtering timeline data, in accordance with an example embodiment. In this example, the method 706B may include operations such as accessing target content data 902, determining whether the content identification data match the target content data 904, and selecting the matching content identification data 906. The example method 706B will be described, by way of explanation, below as being performed by certain modules. It will be appreciated, however, that the operations of the example method 706B can be performed in any suitable order by any number of the modules shown in FIG. 2. It will also be appreciated that the filtering methods 706A, 706B may be performed alone or in combination.

The method 706B, starting at block 902 and proceeding to block 904, includes accessing target content data. For example, the database management module 206 may access the target content data by accessing the database 126 of FIG. 1 by using the data access module 204. The target content data may include data suitable for determining a preference of one particular media content over another. For example, the target content data may correspond to a list of media content to provide in the digital timeline if the media content are related to a timeline event. Additionally or alternatively, the target content data may correspond to one or more pairs of content identifiers and preference values. The preference values may be used to determine a ranking or to threshold for displaying digital content on the digital timeline. For example, the database management module 206 may select, for example, the three books having the highest preference values, or may select only those books having a preference value greater than a predetermined threshold. It will be appreciated the number of content included for each storyline event may vary and may be selected based on the available screen area of the user device.

After accessing the target content data of the user, the method 706B may proceed to block 906 for determining whether related media content of the selected character data structure match the target content data. In an example embodiment, the database management module 206 may determine whether the target content data correspond to the respective digital content indicated by the related products data field 428 of the event data array 412 of the respective character data structure. For example, the database management module 206 may determine a match for digital content indicated by the related products data field 428 that corresponds to a book identified by the target content data. In an alternative embodiment, the database management module 206 may, in accordance with the target content data, assign values to the media content indicated by the related products data field 426 of the event data array 412. The values may indicate preference levels. Accordingly, the database management module 206 may determine matches for the media content indicated by the related products data field 428 based on a threshold and/or ranking their assigned values.

After determining whether the related digital content of the selected character data structures match the target content data, the method 706B may proceed to block 908 for selecting the related digital content that were determined to match the target content data. In this way, the digital content system 200 may facilitate displaying related digital content on displays having limited display areas and may facilitate improved recommendations of digital content to the users. At block 910, the method 706B may end.

### Example Mobile Device

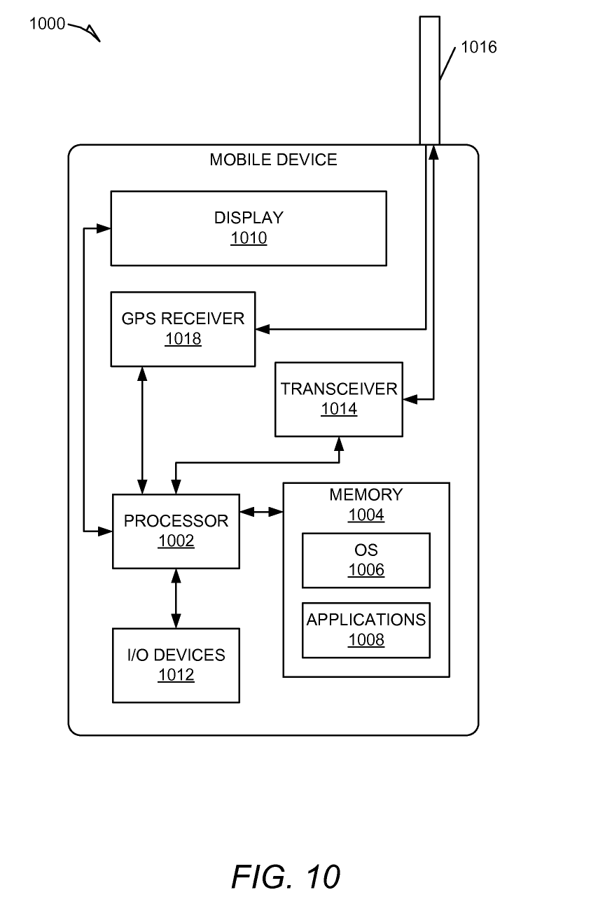

FIG. 10 is a block diagram illustrating a mobile device 1000, according to an example embodiment. The mobile device 1000 may include a processor 1002. The processor 1002 may be any of a variety of different types of commercially available processors suitable for mobile devices (for example, an XScale architecture microprocessor, a Microprocessor without Interlocked Pipeline Stages (MIPS) architecture processor, or another type of processor). A memory 1004, such as a random access memory (RAM), a Flash memory, or other type of memory, is typically accessible to the processor. The memory 1004 may be adapted to store an operating system (OS) 1006, as well as application programs 1008, such as a mobile location enabled application that may provide Location Based Services (LBSs) to a user. The processor 1002 may be coupled, either directly or via appropriate intermediary hardware, to a display 1010 and to one or more input/output (I/O) devices 1012, such as a keypad, a touch panel sensor, a microphone, and the like. Similarly, in some embodiments, the processor 1002 may be coupled to a transceiver 1014 that interfaces with an antenna 1016. The transceiver 1014 may be configured to both transmit and receive cellular network signals, wireless data signals, or other types of signals via the antenna 1016, depending on the nature of the mobile device 1000. Further, in some configurations, a GPS receiver 1018 may also make use of the antenna 1016 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

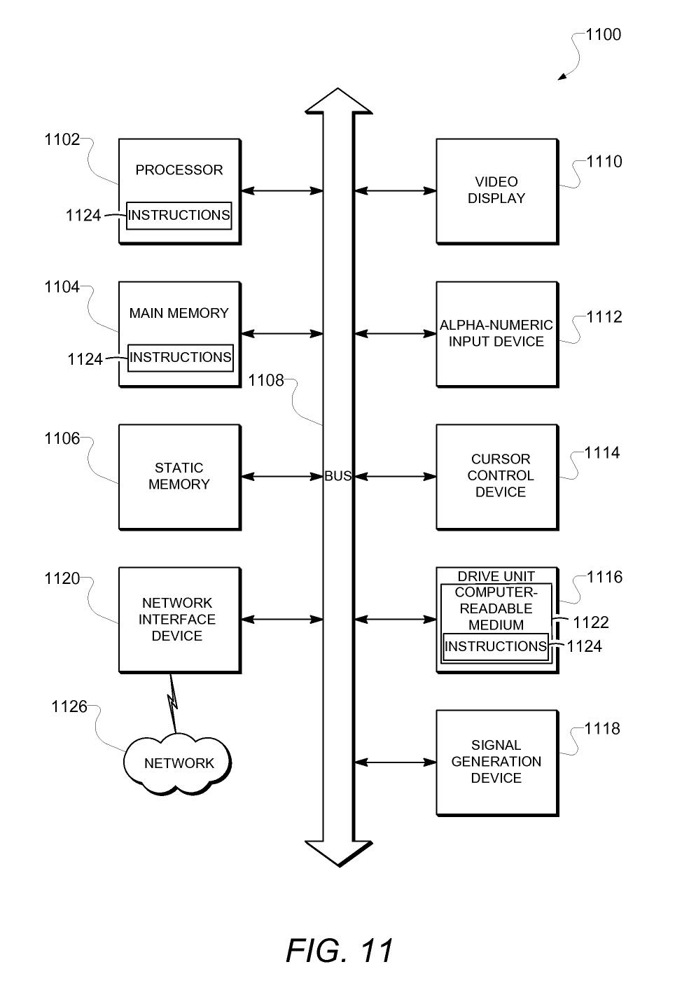

FIG. 11 is a block diagram of machine in the example form of a computer system 1100 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1100 includes a processor 1102 (e.g., a central processing unit (CPU), a graphics processing unit (GPU) or both), a main memory 1104 and a static memory 1106, which communicate with each other via a bus 1108. The computer system 1100 may further include a video display unit 1110 (e.g., a liquid crystal display (LCD) or a cathode ray tube (CRT)). The computer system 1100 also includes an alphanumeric input device 1112 (e.g., a keyboard or a touch-sensitive display screen), a user interface (UI) navigation device 1114 (e.g., a mouse), a disk drive unit 1116, a signal generation device 1118 (e.g., a speaker) and a network interface device 1120.

### Machine-Readable Medium

The disk drive unit 1116 includes a machine-readable medium 1122 on which is stored one or more sets of instructions and data structures (e.g., software) 1124 embodying or utilized by any one or more of the methodologies or functions described herein. The instructions 1124 may also reside, completely or at least partially, within the main memory 1104 and/or within the processor 1102 during execution thereof by the computer system 1100, the main memory 1104 and the processor 1102 also constituting machine-readable media.

While the machine-readable medium 1122 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any non-transitory, tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1124 may further be transmitted or received over a communications network 1126 using a transmission medium. The instructions 1124 may be transmitted using the network interface device 1120 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed:

1. A system comprising:
one or more processors;
an online marketplace interface module configured to provide media content, the online marketplace interface module being further configured to receive, from a user device, a first message including target identification data identifying a target character;
a data access module configured to access, in response to receiving the first message, a database storing data structures, the respective data structures including:
character identification data;
event data indicative of a plurality of storyline events; and
content identification data for the respective storyline events, the content identification data identifying one or more items of media content of the online marketplace related to the respective storyline events; and
a database management module configured to provide, executable by the one or more processors, timeline data for display on the user device, the timeline data being based on the event data of a selected data structure, the timeline data including data for graphical indications of the one or more items of media content indicated by the content identification data of the selected data structure.

2. The system of claim 1, wherein the database management module is configured to provide the timeline data by being configured to:
determine whether the target identification data matches respective character identification data of the data structures; and
select the one of the data structures in accordance with the target identification data matching the character identification data of the corresponding data structure.

3. The system of claim 1, wherein a respective one of the graphical indications includes a hyperlink linking to a marketplace resource providing access to a digital book indicated by the content identification data of the selected data structure.

4. The system of claim 1, wherein the timeline data includes the plurality of storyline events for display in chronological order.

5. The system of claim 1, wherein the receiving of the first message is responsive to a user of the user device selecting a hyperlink of a digital book.

6. The system of claim 1, wherein the receiving of the first message is responsive of a user of the user device selecting a hyperlink of an online marketplace resource provided by the online marketplace interface module.

7. The system of claim 1, wherein the online marketplace interface module is configured to select the event data for the timeline data based on read history data of a user of the user device.

8. The system of claim 7, wherein the online marketplace interface module is configured to select the event data for the timeline data by being configured to:
access history data of the user;
determine whether respective ones of the plurality of storyline events match the access history data; and
select the event data that correspond to storyline events in accordance with a determination that the selected event data match the access history data.

9. The system of claim 1, wherein the online marketplace interface module is configured to select a portion of the content identification data based on target content data.

10. The system of claim 9, wherein the online marketplace interface module is configured to select the portion of the book identification data by being configured to:
access the target content data;
determine whether respective ones of the content identification data match the target content data; and
select the portion of the content identification data in accordance with a determination that the portion matches the target content data.

11. A method for linking content, the method comprising:
providing access to media content of an online marketplace;
receiving, from a client device, a first message indicative of a selection of a target character, the first message including target identification data indicative of the target character;
accessing, in response to receiving the first message, a database storing data structures, the respective data structures including:
character identification data;
event data indicative of a plurality of storyline events; and
content identification data for the respective storyline events, the content identification data identifying one or more items of media content of the online marketplace related to the respective storyline events; and
providing, executable by one or more processors, timeline data for display on the user device, the timeline data being based on the event data of a selected data structure, the timeline data including data for graphical indications of the one or more items of media content indicated by the content identification data of the selected data structure.

12. The method of claim 10, wherein the providing of the timeline data comprises:
determining whether the target identification data matches respective character identification data of the data structures; and
selecting the one of the data structures in accordance with the target identification data matching the character identification data of the corresponding data structure.

13. The method of claim 10, wherein a respective one of the graphical indications includes a hyperlink linking to a marketplace resource to provide access to a digital book in accordance with the content identification data of the selected data structure.

14. The method of claim 10, wherein the timeline data includes the plurality of storyline events for display in chronological order.

15. The method of claim 10, wherein the receiving of the first message is responsive to a user of the user device selecting a hyperlink of a digital book.

16. A machine-readable storage medium embodying instructions that, when executed by a machine, cause the machine to perform operations comprising:
providing access to media content of an online marketplace;
receiving, from a client device, a first message indicative of a selection of a target book character, the first message including target identification data indicative of the target character;
accessing, in response to receiving the first message, a database storing data structures, the respective data structures including:
character identification data;
event data indicative of a plurality of storyline events; and
content identification data for the respective storyline events, the content identification data identifying one or more items of media content of the online marketplace related to the respective storyline events; and
providing, executable by one or more processors, timeline data for display on the user device, the timeline data being based on the event data of a selected data structure, the timeline data including data for graphical indications of the one or more items of media content indicated by the content identification data of the selected data structure.

17. The machine-readable storage medium of claim 16, wherein the providing of the timeline data comprises:
determining whether the target identification data matches respective character identification data of the data structures; and
selecting the one of the data structures in accordance with the target identification data matching the character identification data of the corresponding data structure.

18. The method of claim 16, wherein a respective one of the graphical indications includes a hyperlink linking to a marketplace resource to provide access to a digital book in accordance with the content identification data of the selected data structure.

19. The method of claim 16, wherein the timeline data includes the plurality of storyline events for display in chronological order.

20. The method of claim 16, wherein the receiving of the first message is responsive to a user of the user device selecting a hyperlink of a digital book.
